(19) United States
(12) Patent Application Publication
(10) Pub. No.: US 2018/0110302 A1
(43) Pub. Date: Apr. 26, 2018

(54) CONTINUOUS ELEMENT SLIDE FASTENER

(71) Applicants: Chao-Mu CHOU, Taipei (TW); Shiu-Yin CHENG, Taoyuan City (TW)

(72) Inventor: Chao-Mu CHOU, Taipei (TW)

(21) Appl. No.: 15/783,124

(22) Filed: Oct. 13, 2017

(30) Foreign Application Priority Data
Oct. 24, 2016 (TW) 105134347

(51) Int. Cl. A44B 19/30; A44B 19/40; B29C 65/00; A44B 19/26

(52) U.S. Cl. CPC A44B 19/303; A44B 19/406; B29L 2005/00; A44B 19/262; B29C 66/81423

(57) ABSTRACT

A continuous element slide fastener, which includes: a pair of support tapes, arranged in parallel, wherein a gap is formed between the pair of support tapes, each of the support tapes is formed with a first surface and a second surface which are oppositely arranged; and a pair of continuous-type coupling elements, respectively disposed at an inner edge of each of the second surfaces of the pair of support tapes, wherein each of the continuous-type coupling elements is formed with a connection surface and a fastening surface which are oppositely arranged, and the connection surface is formed with a first protrusion; when the slide fastener is in a coupled status, the highest positions of the first protrusions of the pair of continuous-type coupling elements are located in the gap, and the highest positions of the first protrusions are higher than the second surfaces.

### BACKGROUND OF THE INVENTION

### 1. Field of the Invention

The present invention relates to a slide fastener, especially to a continuous element slide fastener in which a single surface defined on a pair of support tapes is disposed with a pair of continuous-type coupling elements, a connection surface of each of the continuous-type coupling elements is formed with a first protrusion, and the highest position of the first protrusion is located in a gap of the pair of support tapes.

### 2. Description of Related Art

A continuous element slide fastener is formed with a first surface and a second surface. Generally, of the first surface and the second surface, one surface where a continuous-type coupling element is disposed is defined as a front surface, and the other surface where the continuous-type coupling element is not disposed is defined as a rear surface, so that there are two ways for a normal or a reverse operation. When the continuous-type coupling element is used for the reverse operation, a reverse slider has to be provided and a problem of the slide fastener being abnormally coupled often occurs. The problem is generally caused by a gap generated when a pair of support tapes in a left/right symmetrical status are disposed between the continuous-type coupling element and an inner surface of the slider. To overcome the problem, a ridge is generally formed on the inner surface of the slider for compensating the gap and pressing the continuous-type coupling element, so that the continuous-type coupling element can be kept in a horizontal status inside the slider and be coupled normally.

However, the freedom of space arrangement for the shape, the height and the length of the ridge of the inner surface of the above-mentioned reverse slider is very much limited, especially for a reverse auto-lock slider having a lock-pin. As a result, although there are various means for disposing the ridge for meeting certain requirements, those means are generally accompanied with some limitations and affections to the zipping/unzipping of the slide fastener as listed below:
1. The shape and the size of the ridge have to be matched with an opening unit of the slide fastener, otherwise the opening unit will be uneasy to be disposed.
2. For enabling a lock-pin to be accommodated in the auto-lock slider, a design of half-sided ridge is often adopted; said deign will let the side having no ridge be disposed inside the slider to provide a greater opening height and space. However, when the continuous-type coupling elements are disposed in the slider for being sequentially and mutually coupled, only one of the continuous-type coupling elements, for example the continuous-type coupling element at the left side, will be pressed by the half-sided ridge, and therefore the continuous-type coupling element at the left side and the continuous-type coupling element at the right side may be up/down staggered and unable to be normally coupled. In addition, the coupling element is tend to be worn by the ridge, so the coupling end of the continuous-type coupling element will gradually become smaller, and a permanent coupling problem will be caused at the exact location of the slide fastener, especially when the slide fastener is pulled by an external transversal force, the above-mentioned problem is more likely to happen.

For further illustrating the disadvantages of the above-mentioned slider, referring to FIG. 1, which is a cross sectional view of a conventional size #5 reverse auto-lock slider, an inward abutting surface 31 of the slider 3 is formed with an inward abutting ridge 32, the inward abutting ridge 32 is arranged at left-half side, so that the slider 3 is suitable to be applied in an opening slide fastener with a inserting at right side and pulling at left side fashion, and a lock-pin hole 33 is disposed on the inward abutting surface 31 at the right side of the inward abutting ridge 32. The slide fastener further includes a pair of support tapes 1, a gap is formed between inner edges of the pair of support tapes 1, and the bottom surface defined at the inner edges of the pair of support tapes 1 is disposed with a pair of continuous-type coupling elements 2.

The height of the inward abutting ridge 32 is about 0.35 mm, the right side of the continuous-type coupling element 2 is not pressed by any ridge, the left side of the continuous-type coupling element 2 is pressed by the inward abutting ridge 32 and an inward abutting bottom ridge 35 inside the slider 3. As a result, a situation of being up/down staggered is very likely to happen when the continuous-type coupling elements 2 are mutually coupled. As can be seen in the figure, a horizontal level difference Y is formed both between the continuous-type coupling element 2 at the right side and the inner bottom ridge 35, and between the continuous-type coupling element 2 at the right side and a main body at the lower portion of the slider 3, and thus the coupling operation will fail most of the time, especially when the pair of continuous-type coupling elements 2 of the slide fastener are subjected to transversal pulling forces.
3. For enabling the reverse auto-lock slider to accommodate the lock-pin, the design of having half-sided ridge is often adopted. However, as the above-mentioned design has to prepare the sliders with both left-insert (right pull) fashion and the right-insert (left pull) fashion, the inventory will be increased substantially and the production cost will be much higher.
4. To overcome the above-mentioned disadvantages, a design of full ridge is adopted in the reverse auto-lock slider, in other words the lock-pin hole is formed in the interior of the ridge. However, with the above-mentioned design, the ridge will become wider and the internal space of the slider will become smaller, the friction between the slide fastener and the slider will be increased, and the continuous-type coupling elements will be more easily worn and damaged, and thus the service life of the slide fastener will be shortened and the opening unit will be difficult to be disposed. In addition, the shape and volume of the ridge will be required to be altered and reduced for accommodating the lock-pin, so the production will be more difficult, and a situation of the ridge being broken will happen more frequently to cause damage to the pair of continuous-type coupling elements and the pair of support tapes.

On the other hand, referring to FIG. 2, which is a cross sectional view of a conventional size #5 continuous-type coupling element, the top of the continuous-type coupling element 2 is formed with a recess part 25 which is not used for accommodating a pair of left/right arranged support tapes as what is claimed in the present invention but used for accommodating at least one sewing stitch 5, the function of the recess part 25 is to reduce the wearing of the at least one sewing stitch 5; thus the highest position of the continuous-type coupling element 2 is not located in a gap of the pair of support tapes.

Accordingly, through altering the shape of the conventional continuous-type coupling element, the distance defined between the continuous-type coupling element and the inward abutting surface of the slider can be compensated, so that the height of the ridge can be lowered or the ridge can be even not needed, or the ridge can be replaced by a concave slot; thus, the pair of continuous-type coupling elements inside the slider can be kept in the horizontal status for enhancing the coupling stability; the internal space of the slider can be expanded for having more space to design the lock pin and the opening unit, thereby greatly increasing the coupling quality of the slide fastener. In addition, the pair of continuous-type coupling elements can be provided with contrast colors relative to the pair of support tapes, thereby allowing the slide fastener to be provided with a decorative effect.

### SUMMARY OF THE INVENTION

One primary objective of the present invention is to provide a continuous element slide fastener having a pair of continuous-type coupling elements, the highest position of a first protrusion of each of the continuous-type coupling elements is located in the gap of a pair of support tapes, and higher than a second surface of the pair of support tapes; as a result, the height of a ridge inside the reverse slider can be lowered, and the completeness of the casting formation of the ridge can be enhanced.

Another objective of the present invention is to provide a continuous element slide fastener, in which a pair of continuous-type coupling elements and a pair of support tapes have different colors, thereby providing a better visual effect.

For achieving said objectives, one technical solution provided by the present invention is to provide a continuous element slide fastener, which includes: a pair of support tapes, arranged in parallel, wherein a gap is formed between the pair of support tapes, each of the support tapes is formed with a first surface and a second surface which are oppositely arranged; and a pair of continuous-type coupling elements, respectively disposed at an inner edge of each of the second surfaces of the pair of support tapes, wherein each of the continuous-type coupling elements is formed with a connection surface and a fastening surface which are oppositely arranged, and the connection surface is formed with a first protrusion; when the slide fastener is in a coupled status, the highest positions of the first protrusions of the pair of continuous-type coupling elements are located in the gap, and the highest positions of the first protrusions are higher than the second surfaces.

For achieving said objectives, another technical solution provided by the present invention is to provide a continuous element slide fastener, which includes: a pair of support tapes, arranged in parallel, wherein a gap is formed between the pair of support tapes, each of the support tapes is formed with a first surface and a second surface which are oppositely arranged; a pair of continuous-type coupling elements, respectively disposed at an inner edge of each of the second surfaces of the pair of support tapes, wherein each of the continuous-type coupling elements is formed with a connection surface and a fastening surface which are oppositely arranged, and the connection surface is formed with a first protrusion, when the slide fastener is in a coupled status, the highest positions of the first protrusions of the pair of continuous-type coupling elements are located in the gap, and the highest positions of the first protrusions are higher than the second surfaces; and at least one slider, allowing the pair of support tapes and the pair of continuous-type coupling elements to be received, wherein the interior of the at least one slider is formed with an inward abutting surface and an inward abutting bottom surface which are oppositely arranged, and a shape formed inside the at least one slider is corresponding to the highest positions of the first protrusions at a path where the pair of continuous-type coupling elements being coupled or separated, thereby enabling the pair of continuous-type coupling elements to be sequentially coupled or separated.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a cross sectional view illustrating a conventional slide fastener in which a slider having a half-sided inward abutting ridge for causing a pair of continuous-type coupling elements to be up/down staggeringly arranged inside the slider;

FIG. 2 is a cross sectional view illustrating a conventional continuous-type coupling element in which the top surface thereof being formed with a recess part used for reducing the friction between sewing stitch and the inward abutting surface of the slider;

FIG. 3a is a cross sectional view illustrating a continuous-type coupling element and a support tape according to a first embodiment of the present invention;

FIG. 3b illustrates a cross sectional view of a pair of continuous-type coupling elements without a cord bound with a pair of support tapes and a pair of narrow tapes according to an alternative embodiment of the present invention;

FIG. 4 is a cross sectional view illustrating relative locations of the continuous-type coupling element, the support tape and a slider shown in FIG. 3a;

FIG. 5 is a cross sectional view illustrating the continuous-type coupling element and the support tape according to a second embodiment of the present invention;

FIG. 6 is a cross sectional view illustrating the continuous-type coupling element and the support tape shown in FIG. 5 according to an alternative embodiment of the present invention;

FIG. 7 is a cross sectional view illustrating the continuous-type coupling element and the support tape shown in FIG. 5 according to another alternative embodiment of the present invention;

FIG. 8 is a cross sectional view illustrating relative locations of the continuous-type coupling element, the support tape and the slider according to a third embodiment of the present invention;

FIG. 9 is a cross sectional view illustrating the continuous-type coupling element shown in FIG. 5 being coated with a waterproof coating layer at the support tape and the gap;

FIG. 10 is a cross sectional view illustrating the continuous-type coupling element shown in FIG. 5 being filled with a waterproof gel member at the gap and the interstice of the pair of continuous-type coupling elements, and a waterproof layer being adhered on the pair of support tapes and the gap;

FIG. 11 is a cross sectional view illustrating the slide fastener in which the highest position of the first protrusion of the pair of continuous-type coupling elements being aligned with the first surface of the pair of support tapes according to the present invention;

FIG. 12 is a cross sectional view illustrating the slide fastener in which the highest position of the first protrusion of the pair of continuous-type coupling elements being higher than the first surface of the pair of support tapes according to the present invention;

FIG. 13 is a cross sectional view illustrating the pair of continuous-type coupling elements being formed with the first protrusion and the second protrusion, and the highest position of the first protrusion is higher than the first surface of the pair of support tapes according to the present invention; and

FIG. 14 is a cross sectional view illustrating the slider in which the first concave slot and the grooves being formed on the inward abutting bottom surface of the slider according to the present invention.

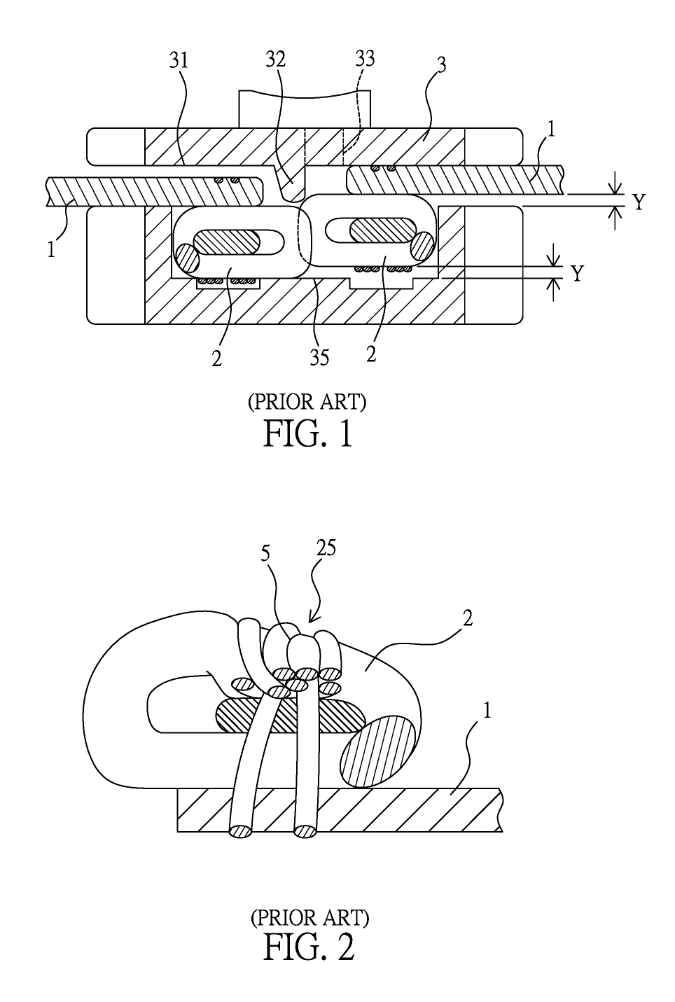

### DETAILED DESCRIPTION OF THE PREFERRED EMBODIMENT

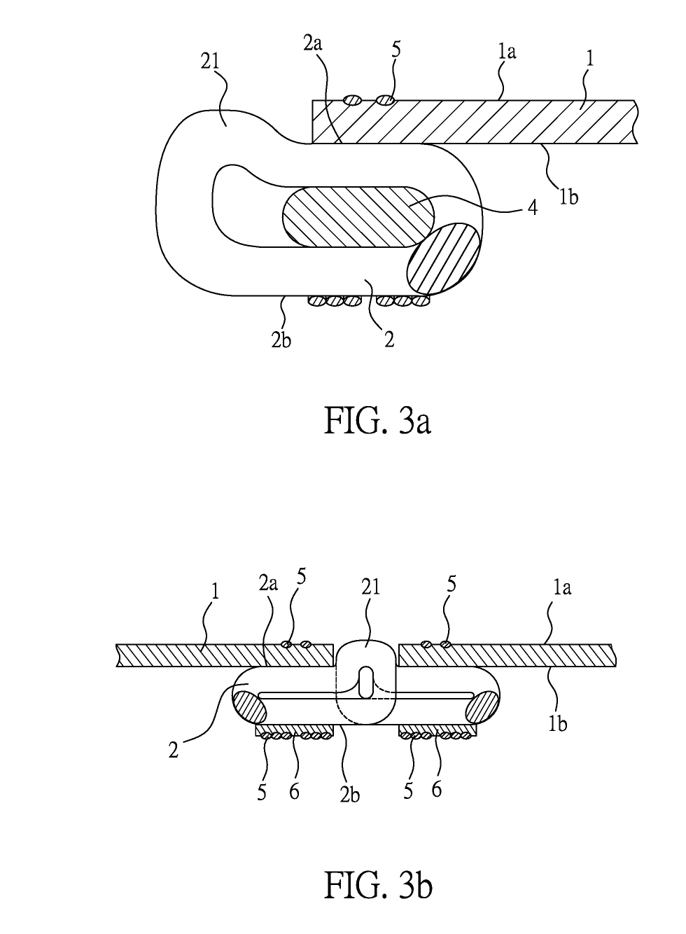

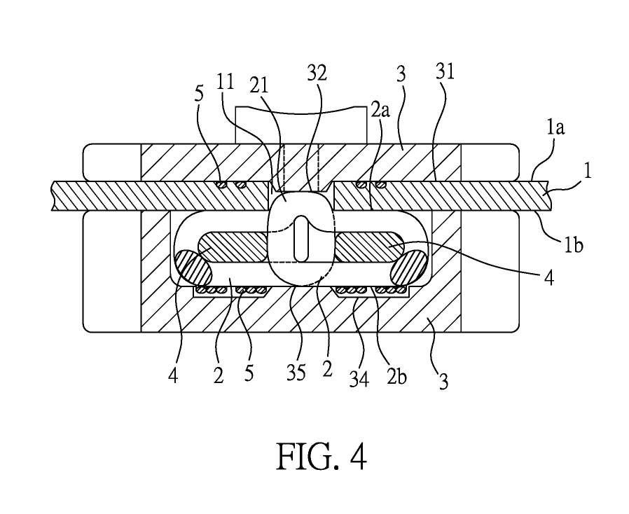

Referring to FIG. 3a and FIG. 4, a continuous element slide fastener including a pair of support tapes 1 arranged in parallel is provided by the present invention, and a gap 11 is formed between the pair of support tapes 1. Each of the support tapes 1 is formed with a first surface 1a, for example a top surface, and a second surface 1b, for example a bottom surface, which are oppositely arranged. An inner edge of each of the second surfaces 1b is disposed with a continuous-type coupling element 2, for example a continuous-coil type coupling element. The continuous-type coupling element 2 is formed with a connection surface 2a, for example a top surface, and a fastening surface 2b, for example a bottom surface, which are oppositely arranged. At least one slider 3 is provided for allowing the pair of support tapes 1 and the pair of continuous-type coupling elements 2 to be received therein, so that the pair of continuous-type coupling elements 2 can be sequentially coupled or separated. The continuous-type coupling elements 2 can be respectively provided with or without a cord 4, and at least one sewing stitch 5 is utilized for sewing and fastening each of the continuous-type coupling elements 2 at the inner edge of the second surface 1b of each of the support tapes 1. For an embodiment of the continuous-type coupling elements 2 without the cord 4, please refer to FIG. 3b, which illustrates a cross sectional view of a pair of continuous-type coupling elements without a cord bound with a pair of support tapes and a pair of narrow tapes according to an alternative embodiment of the present invention. As illustrated in FIG. 3b, two narrow tapes 6 are disposed each on one of the continuous-type coupling elements 2 at the fastening surface 2b and are bound together with the coupling elements 2 and the support tapes 1 by the sewing stitches 5, so as to reinforce the cross broken strength of the continuous element slide fastener implemented without the cord 4 in the continuous elements 2. What shall be stressed here is that the arrangements mentioned above are prior art, and therefore will not be further addressed.

One technical feature of the pair of continuous-type coupling elements 2 is that a first protrusion 21 is formed on the connection surface 2a. With the different amount, the position and the height of the first protrusion 21 formed on each of the continuous-type coupling elements 2, various functions and effects can be provided, and the coupling stability of the slide fastener can be enhanced, meanwhile colorful appearance can be provided to the slide fastener.

As shown in FIG. 3 and FIG. 4, the first protrusion 21 is formed at a coupling end of the connection surface 2a of the continuous-type coupling element 2, and the highest position of the first protrusion 21 is higher than the second surface 1b of the support tape 1, but lower than the first surface 1a of the support tape 1; for example if the thickness of the support tape 1 is 0.50 mm, and the height of the first protrusion 21 is 0.35 mm, the height of an inward abutting ridge 32 formed on an inward abutting surface 31 of the slider 3 can be reduced to 0.15 mm or even lower, so that a full ridge design can be adopted, and the pair of continuous-type coupling elements 2 can be pressed by the inward abutting ridge 32 disposed inside the slider 3, thus a problem of the pair of continuous-type coupling elements 2 being unable to be horizontal inside the slider 3 can be greatly improved, and another problem of poor coupling of a reverse slide fastener can also be overcome.

As such, under a condition of the internal height of the slider 3 not being altered, when the height of the inward abutting ridge 32 is reduced to at least 0.15 mm, the internal space inside the slider 3 can be relatively expanded, so that there is more room for designing molds for a lock-pin and an opening unit (not shown in figures), meanwhile the pair of continuous-type coupling elements 2 can be prevented from being worn, so as to increase the sliding smoothness and to greatly increase the quality and the service life of the slide fastener.

Referring to FIG. 5, which is cross sectional view illustrating the continuous-type coupling element, a continuous-folding type coupling element, and the support tape according to a second embodiment of the present invention. The first protrusion 21 is formed at the coupling end of the connection surface 2a of the continuous-type coupling element 2, and a second protrusion 22 is formed at a coupling end of the fastening surface 2b of the continuous-type coupling element 2, the highest position of the first protrusion 21 is higher than the second surface 1b of the support tape 1, but lower than the first surface 1a of the support tape 1. As such, according to this embodiment, the height of the inward abutting ridge 32 can be lowered, and an inward abutting bottom ridge (as shown in FIG. 12) formed on an inward abutting bottom surface 34 of the slider 3 can be eliminated, thus the horizontal level of the pair of continuous-type coupling elements 2 in the slider 3 can be kept.

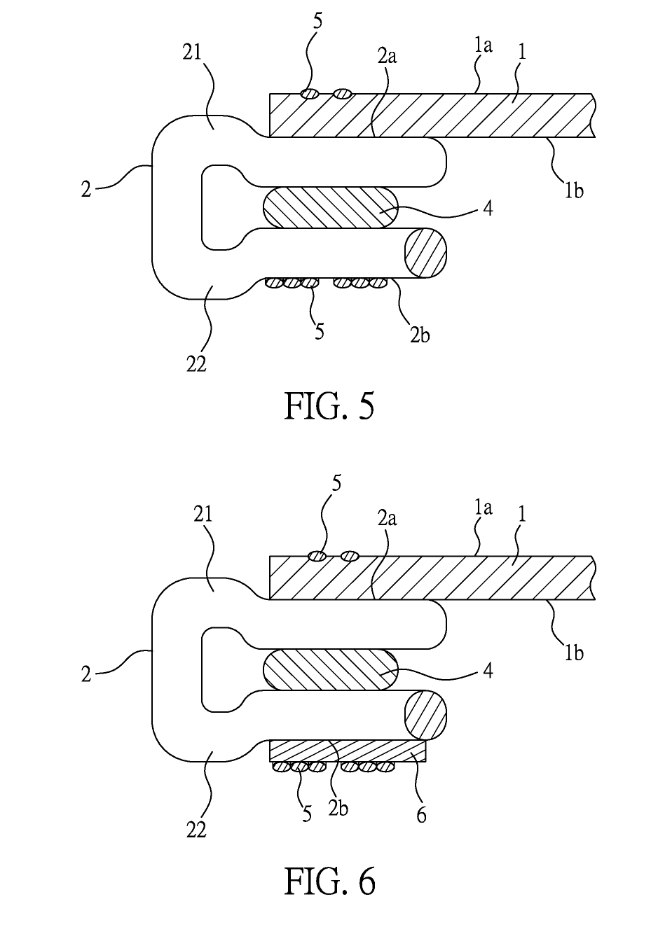

Referring to FIG. 6, the fastening surface 2b of the continuous-type coupling element 2 can be provided with a narrow tape 6, the at least one sewing stitch 5 is utilized for sewing and fastening the narrow tape 6 together with the support tape 1 and the continuous-type coupling element 2, thus the narrow tape 6 is fastened on the fastening surface 2b, and the durability of the slide fastener can be enhanced.

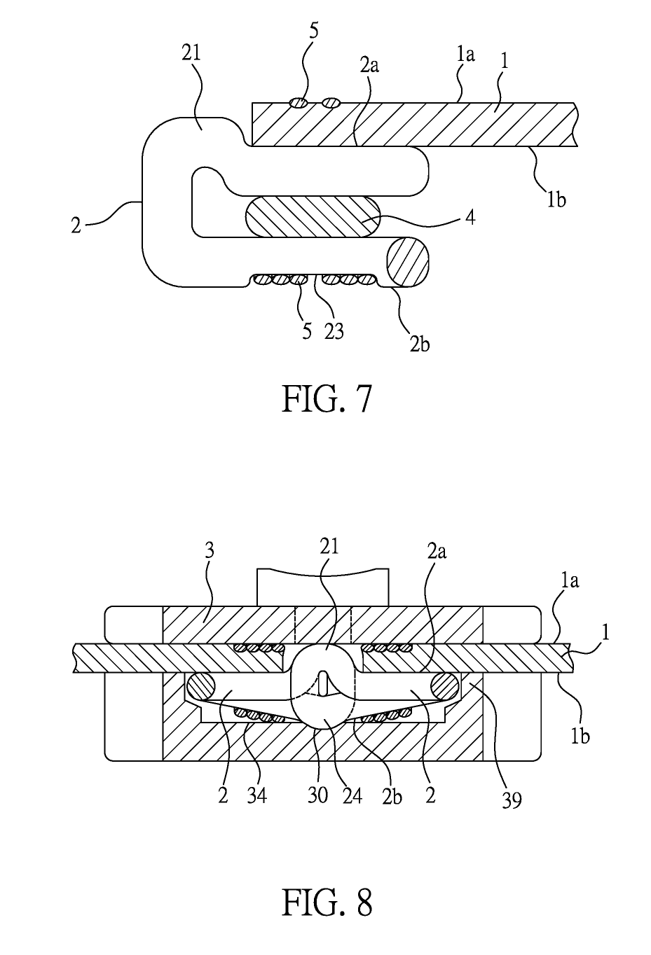

Referring to FIG. 7, the fastening surface 2b of the continuous-type coupling element 2 is formed with an accommodation slot 23, the accommodation slot 23 is served to accommodate the at least one sewing stitch 5, thus the friction between the sewing stitch 5 and the inward abutting bottom surface 34 (as shown in FIG. 4) of the slider 30 can be reduced, thereby enhancing the durability of the slide fastener.

The formation method of the first protrusion 21 and that of the second protrusion 22 can be different with respect to different kinds of the continuous-type coupling elements 2, for example the first protrusion 21 and the second protrusion 22 of the continuous-type coupling element 2 in a coil shape can be formed through a central rod having a special shape, such as L-like shape or T-like shape, and processed with a pressing treatment in a heating formation zone with a pressing wheel or pressing roller, or formed through a bending means disclosed in U.S. Pat. No. 5,135,699. In addition, the first protrusion 21 and the second protrusion 22 of the continuous-type coupling element 2 in a folded shape can be formed through a means disclosed in U.S. Pat. No. 3,908,242, a heated pressing wheel having a special shape and a pressing method are utilized for formation. Or after an initial formation step, moving to the exterior and utilizing a shaping mold for formation, such as the means disclosed in U.S. Pat. No. 3,836,413, and the shaping mold can be designed with respect to whether the continuous-type coupling element having a cord 4. But what shall be addressed is that the above-mentioned formation means for the first protrusions and the second protrusions of the pair of continuous-type coupling elements are well known by the skilled people, therefore no further illustration is provided.

Referring to FIG. 8, which is a cross sectional view illustrating relative locations of the continuous-type coupling element, the support tape and the slider according to a third embodiment of the present invention, and the slide fastener is a woven-in slide fastener (or woven-in zipper). An inner chamber of the continuous-type coupling element 2, for example the continuous-type coupling element in the coil shape, is not provided with the cord 4, and the portions of the connection surface 2a and the fastening surface 2b of each of the continuous-type coupling elements 2 defined outside the coupling ends are staggeringly arranged in the horizontal level, thus two sides of each of the continuous-type coupling elements 2 are relatively thinner, the coupling end is relatively thicker, and the appearance of the fastening surface 2b is formed in a round and thick shape similar to a protrusion.

When the slide fastener is in a coupled status, the inner bottom surface 34 of the slider 3 is only in contact with the bottom surface of the coupling end of the fastening surface 2b of the continuous-type coupling element 2, so that two sides of the pair of continuous-type coupling elements 2 are in a suspended status, and the pair of continuous-type coupling elements 2 may swing in the left/right direction inside the slider 3, especially when the thickness of the continuous-type coupling element of the woven-in slide fastener is thinner than that of the continuous-type coupling element fastened via the above-mentioned sewing means; thus the internal height of a mated slider is lower, in other words the height of a pair of side walls 39 of the slider is relatively lower. As such, when the pair of continuous-type coupling elements 2 are in an inclined status inside the slider 3, one of the pair of continuous-type coupling elements 2 which is upwardly inclined will be very likely higher than the side wall 39 and therefore not restrained by the side wall 39 of the slider 3, causing the pair of continuous-type coupling elements 2 unable to be normally coupled.

According to this embodiment, the highest position of the first protrusions 21 of the pair of continuous-type coupling elements 2 is higher than the second surface 1b of the pair of support tapes 1, and substantially aligned with the first surface 1a of the pair of support tapes 1, so that there is no need of the conventional inward abutting ridge being disposed inside the slider 3, and an arc-shaped recess 30 is formed at the location where the conventional inward abutting bottom ridge being disposed, thereby allowing an arc-shaped part 24 at the bottom of the coupling end in a coupled status to be received, with the design of the arc-shaped part 24 being received in the arc-shaped recess 30, the pair of continuous-type coupling elements 2 can be kept in the horizontal status in the slider 3, meanwhile the horizontal level of the pair of continuous-type coupling elements 2 in the slider 3 can be lowered, thus the pair of side walls 39 of the slider 3 are able to actually restrain the pair of continuous-type coupling elements 2, thereby solving a problem of poor coupling in the conventional woven-in slide fastener.

Because the pair of continuous-type coupling elements of the woven-in slide fastener may have slight differences due to the size of the slide fastener, for example the thickness defined at the outer side and the coupling end of the continuous-type coupling element of a size #10 woven-in slide fastener is greater than that of a size #3 woven-in slide fastener, thus the arc-shaped recess 30 of the inner bottom surface 34 can be disposed at the location where the convention inward abutting bottom ridge is arranged or at the location where the above-mentioned inward abutting bottom ridge not being arranged, or directly disposed at a proper location on the inward abutting bottom surface 34.

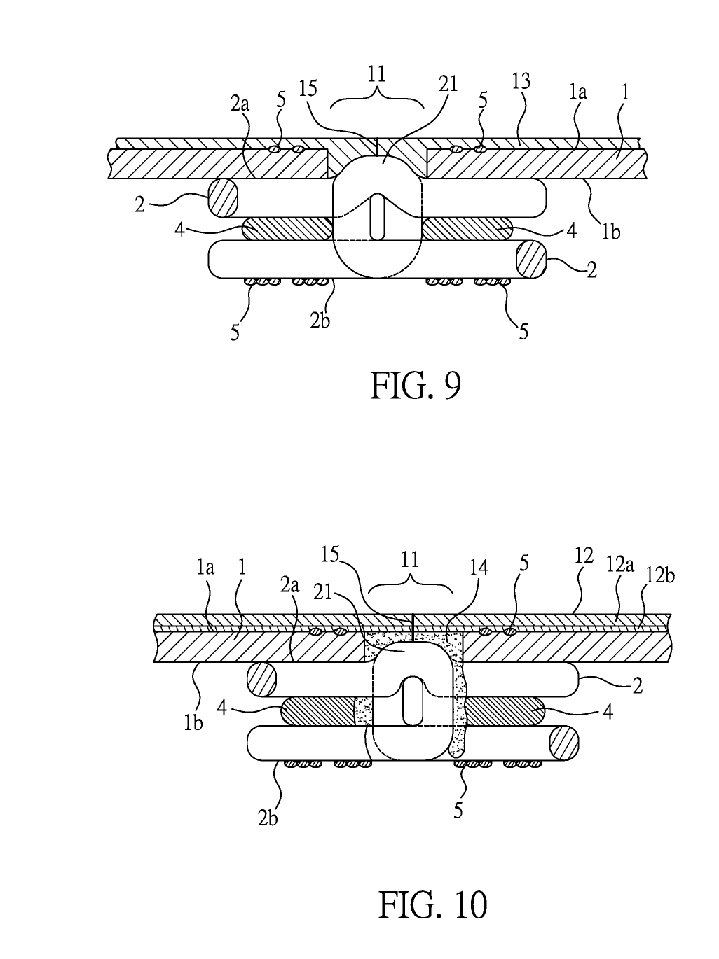

Referring to FIG. 9, when the highest position of the first protrusion 21 is higher than the second surface 1b of the support tape 1, but lower than the first surface 1a, a waterproof coating layer 13 made of an elastic polymer material can be directly coated on the first surface 1a and the gap 11 for increasing the waterproof function of the slide fastener, and the waterproof coating layer 13 is cut in the gap 11 for forming a slit 15.

Referring to FIG. 10, a water impervious member 14 made of an elastic polymer material can be individually filled in the gap 11, so that the water impervious member 14 is formed in the gap 11 and capable of permeating into an interstice of the pair of continuous-type coupling elements 2, and the water impervious member 14 is cut in the gap 11 for forming a slit 15, thereby enabling the slide fastener to be coupled or separated and preventing the fluid from permeating from the gap 11.

Moreover, as shown in FIG. 10, after the water impervious member 14 is filled in the gap 11, a waterproof layer 12 is comprehensively adhered on the first surfaces 1a and the gap 11 of the pair of support tapes 1, and the waterproof layer 12 and the water impervious member 14 are cut in the gap 11 for forming a slit 15, thereby enabling the slide fastener to be coupled or separated and preventing the fluid from permeating from the pair of support tapes 1 and the gap 11 so as to further enhance the waterproof function. Or, a treatment of applying a water repellent agent can be processed on the second surface 1b of the pair of support tapes 1 and the pair of continuous-type coupling elements 2 for further enhancing the waterproof function. Furthermore, in actual practice, the waterproof later 12 can be a coated layer; or the waterproof layer 12 includes a water impervious film 12a and an adhering layer 12b.

As shown in FIG. 9 and FIG. 10, the waterproof means have already been disclosed in Taiwan Pat. No. 1374714 and I395555 (equivalent to U.S. Pat. No. 8,397,353B2 and China Pat. No. CN101744431B and CN101966026), therefore no further illustration is provided.

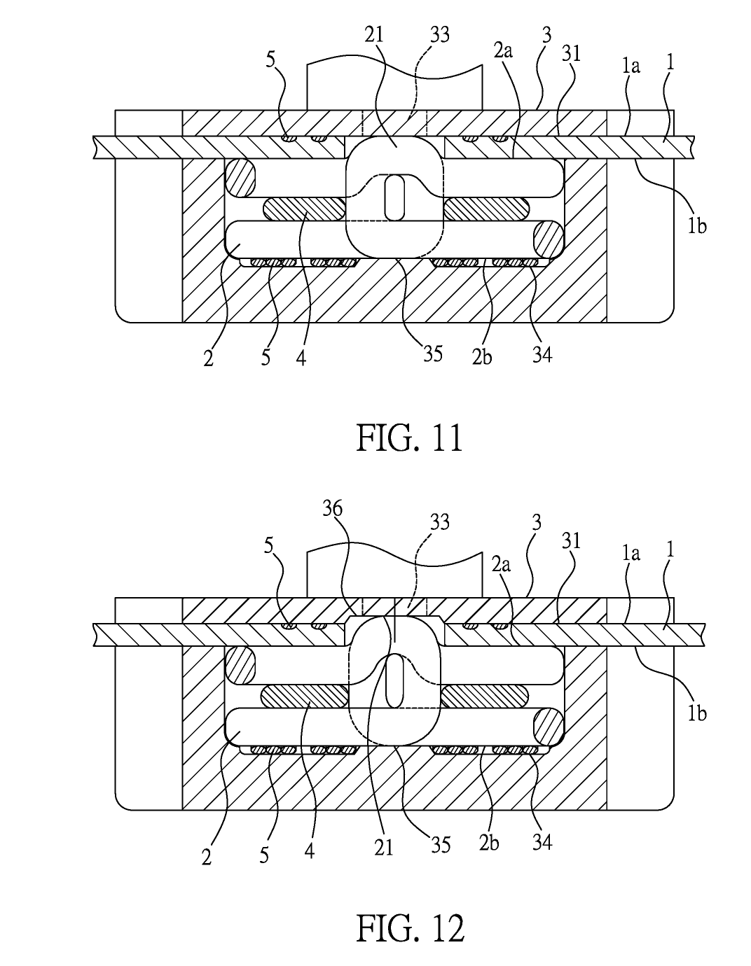

Referring to FIG. 11, the highest position of the first protrusion 21 is higher than the second surface 1b of the support tape 1 and substantially aligned with the first surface 1a of the support tape 1; according to this embodiment, the inward abutting ridge of the inward abutting surface 31 of the slider 3 is not required, and the pair of continuous-type coupling elements 2 can be sequentially coupled at the exact same horizontal level in the slider 3, thus a problem of the pair of continuous-type coupling elements being unable to be in the horizontal status due to a half-sided inward abutting ridge of the conventional reverse slide fastener can be completely eliminated, and another problem of poor coupling of the reverse slide fastener can be overcome.

Moreover, under a condition of not altering the internal height of the slider 3, saving the inward abutting ridge can greatly expand the internal space of the slider 3, so the mold designs for the lock-pin and the opening unit (not shown in figures) can be simplified; because there is no inward abutting ridge on the inward abutting surface 31 of the slider 3, there is no need of considering the relative relation with the inward abutting ridge while designing the desired locations of the lock-pin and a lock-pin hole 33. Under the same condition, there is no need of considering the relative relation with the inward abutting ridge while designing the opening unit. As such, as shown in FIG. 11, a two-way separating slide fastener would benefit the most from the above-mentioned arrangement disclosed in FIG. 11. Furthermore, there is no need of considering whether the slider is a left inserting type or right inserting type, thus the required types and the inventory of the slider can be greatly reduced. Especially, saving the inward abutting ridge allows the pair of continuous-type coupling elements to be prevented from being worn and damaged, so that the sliding smoothness can be enhanced, and the quality and the service life of the slide fastener can be effectively increased.

Referring to FIG. 12, the highest position of the first protrusion 21 can also be higher than the first surface 1a of the support tape 1, and the inward abutting surface 31 of the slider 3 is correspondingly formed with a first concave slot 36 for receiving the first protrusion 21, and the first concave slot 36 is served as a guiding slot for the first protrusion 21, so that the pair of continuous-type coupling elements 2 can be guided for being stably coupled in sequence inside the slider 3, and the conventional design concept for the reverse slide fastener and the slider can be modified, thereby overcoming the problems of the poor coupling and friction existed in the reverse slide fastener.

Moreover, because the highest position of the first protrusions 21 are higher than the first surfaces 1a of the pair of support tapes 1, the first concave slot 36 is formed at a path where the first protrusions 21 being mutually coupled and separated on the pair of continuous-type coupling elements 2, but the first concave slot 36 can be formed on the inward abutting bottom surface 34 of the slider 3 if necessary.

Furthermore, under the condition of the internal height of the slider 3 not being altered, the first concave slot 36 allows the internal space of the slider 3 to be greatly expanded, so that the mold designs for the lock-pin and the opening unit can be simplified, there is no need of considering whether the slider is a left inserting type or right inserting type, and the continuous-type coupling element can be prevented from being worn so as to increase the sliding smoothness, thus the quality and the service life of the slide fastener can be effectively increased.

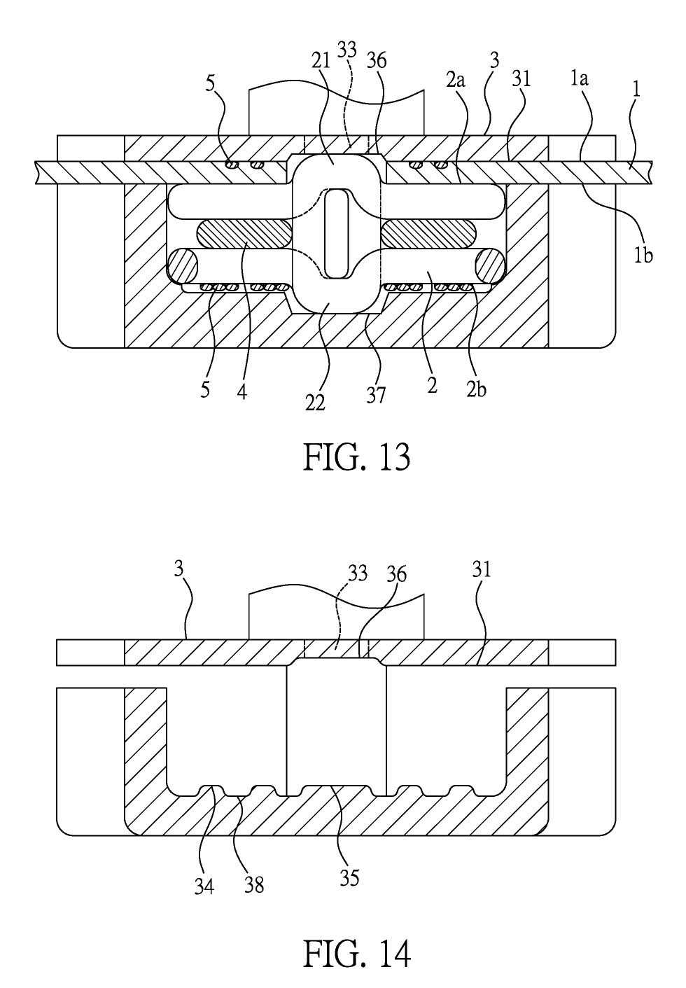

Referring to FIG. 13, if the pair of continuous-type coupling elements 2 are formed with both of the first protrusion 21 and the second protrusion 22, the first protrusion 21 is disposed at the coupling end of the connection surface 2a, and the second protrusion 22 is disposed at the coupling end of the fastening surface 2b. The highest position of the first protrusion 21 is higher than the first surface 1a of the support tape 1, and the highest position of the second protrusion 22 is protruded out from the sewing stitch 5 or the small narrow tape 6 on the fastening surface 2b (as shown in FIG. 6), the inward abutting surface 31 of the slider 3 is formed with the first concave slot 36 capable of receiving the first protrusion 21 at a location corresponding to the first protrusion 21, and the inward abutting bottom surface 34 is formed with a second concave slot 37 capable of receiving the second protrusion 22 at a location corresponding to the second protrusion 22. With the first concave slot 36 and the second concave slot 37, the pair of continuous-type coupling elements 2 can be guided at both top side and bottom side for being stably coupled in sequence in the slider 3. As such, the embodiment disclosed in FIG. 13 is suitable to be applied to a large slide fastener which may be subjected to a large external force, thus the coupling quality of the slide fastener can be greatly improved. For the first protrusion 21 of the above-mentioned pair of continuous-type coupling elements 2 under the condition of the slide fastener being in the coupled status, the width defined at the highest position of the first protrusion 21 is basically smaller than a distance defined at the gap 11 of the pair of support tapes 1, for example the gap 11 of the size #3 slide fastener is preferably to be about 1.6 mm, the gap 11 of the size #5 slide fastener is preferably to be about 1.9 mm, the gap 11 of the size #8 slide fastener is preferably to be about 2.2 mm, but what shall be addressed is that the scope of the present invention is not limited to the above-mentioned arrangement.

According to the embodiment disclosed above, the friction force applied to the slider can be reduced through reducing the contact area with the slide fastener. However, in actual practice, if foreign objects, for example dusts, fall into the interior of the slider, the coupling function of the slide fastener would be greatly affected, meanwhile the interior of the slider would also be worn or even damaged. As such, reducing the affection caused by the foreign objects, for example the dusts, falling into the interior of the slider can increase the durability of the slide fastener, especially for the slide fastener used in an outdoor tent. Referring to FIG. 14, the inner bottom surface 34 of the slider 3 is further formed with a plurality of grooves 38, the grooves 38 are served to reduce the contact area defined between the pair of support tapes 1, the pair of continuous-type coupling elements 2 and the interior of the slider 3, thereby enhancing the durability of the slide fastener. The grooves 38 can also be formed on the inward abutting surface 31 according to the actual needs, and the amount, the width, the depth, the length and the location of the grooves 38 can also be adjusted with respect to the application of the slide fastener.

In view of the color combination, the pair of support tapes 1 and the pair of continuous-type coupling elements 2 have contrast colors, wherein the pair of continuous-type coupling elements 2 can be processed with a printing, dyeing, electroplating or solution dyeing treatment; or the pair continuous-type coupling elements 2 can be individually processed with the printing, dyeing, electroplating or solution dyeing treatment for allowing the pair continuous-type coupling elements 2 to have different colors, and a colorful presentation can be provided while being matched with the pair of support tapes 1 having checks or stripes appearance. Wherein, the above-mentioned printing treatment is to print a pattern on the connection surface of one of the continuous-type coupling elements, and the printed pattern is formed through a thermal paper printing process.

If a warp/weft knitting fabric having elasticity in a warp or a weft direction is adopted in the portion of the pair of support tapes 1 where the pair of continuous-type coupling elements 2 not being disposed, the pair of support tapes 1 is provided with an elastic function in a longitudinal or a transversal direction, for example the Taiwan Pat. No. 222967 (equivalent to U.S. Pat. No. 6,494,236) granted to the applicant of the present invention has disclosed a slide fastener capable of being bent laterally to provide a curved flat surface for presenting more vivid color images, and allow more functional designs, thereby enhancing the visual effect of the product appearance.

Moreover, the slide fastener can be immersed in a water repellent solution then processed with a solidifying treatment, or a plasma means can be used for allowing hydrophobic material to be adhered on the slide fastener, or the slide fastener can be fabricated with fibers having the water repellent function or the above three can be alternatively applied, so that the slide fastener is provided with the water repellent function.

Based on what has been disclosed above, advantages achieved by the present invention are as followings:
1. With the protrusions of the pair of continuous-type coupling elements, the height of the inward abutting ridge inside the slider can be lowered, so that the completeness of the casting formation of the inward abutting ridge can be enhanced during manufacturing, meanwhile the interference between the slider and the opening unit of the slide fastener can be reduced, thereby allowing the slide fastener to be more smoothly operated.
2. With the protrusions of the pair of continuous-type coupling elements, the inward abutting ridge inside the slider is not required, so that the stability of the pair of continuous-type coupling elements being mutually coupled can be enhanced, and the types of the sliders can be reduced so as to lower the inventory and the production management cost.
3. With the protrusions of the pair of continuous-type coupling elements, the original inward abutting ridge inside the slider can be replaced by the first concave slot, or the original inward abutting bottom ridge can be replaced by the second concave slot, so that the concave slots can be served to guide the pair of continuous-type coupling elements to stably couple with each other.
4. The color of the pair of continuous-type coupling elements and the color of the pair of support tapes are different, so that the appearance of the product can be more artistic.
5. The pair of continuous-type coupling elements can be printed with patterns or be electroplated for having different colors relative to the color of the pair of support tapes, so that the appearance of the product can be more artistic.
6. The pair of continuous-type coupling elements and the pair of support tapes having elasticity in the longitudinal direction can be provided with different colors, thereby allowing the functional and the visual effects of the product to be increased.
7. The slide fastener can be processed by utilizing the water repellent agent, or formed with the waterproof layer, the waterproof coating layer or the water impervious member, thereby enhancing the waterproof function of the slide fastener.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

What is claimed is:

1. A continuous element slide fastener, including:
a pair of support tapes, arranged in parallel, and each of said support tapes being formed with a first surface and a second surface which are oppositely arranged; and
a pair of continuous-type coupling elements, respectively disposed at an inner edge of each of said second surfaces of said pair of support tapes, wherein each of said continuous-type coupling elements is formed with a connection surface and a fastening surface which are oppositely arranged, and said connection surface is formed with a first protrusion; when said slide fastener is in a coupled status, a gap will be formed between said pair of support tapes, the highest position of said first protrusion of said pair of continuous-type coupling elements will be located in said gap, and the highest position of said first protrusion will be higher than said second surface.

2. A continuous element slide fastener, including:
a pair of support tapes, arranged in parallel, and each of said support tapes being formed with a first surface and a second surface which are oppositely arranged;
a pair of continuous-type coupling elements, respectively disposed at an inner edge of each of said second surfaces of said pair of support tapes, wherein each of said continuous-type coupling elements is formed with a connection surface and a fastening surface which are oppositely arranged, and said connection surface is formed with a first protrusion, when said slide fastener is in a coupled status, a gap will be formed between said pair of support tapes, the highest position of said first protrusion of said pair of continuous-type coupling elements will be located in said gap, and the highest position of said first protrusion will be higher than said second surface; and
at least one slider, allowing said pair of support tapes and said pair of continuous-type coupling elements to be received, wherein the interior of said at least one slider is formed with an inward abutting surface and an inward abutting bottom surface which are oppositely arranged, and a shape formed inside said at least one slider is corresponding to the highest position of said first protrusion at a path where said pair of continuous-type coupling elements being coupled or separated, thereby enabling said pair of continuous-type coupling elements to be sequentially coupled or separated.

3. The continuous element slide fastener as claimed in claim 1, wherein the highest position of said first protrusion of said pair of continuous-type coupling elements is aligned with said first surface of said support tape.

4. The continuous element slide fastener as claimed in claim 2, wherein the highest position of said first protrusion of said pair of continuous-type coupling elements is aligned with said first surface of said support tape.

5. The continuous element slide fastener as claimed in claim 1, wherein the highest position of said first protrusion of said pair of continuous-type coupling elements is higher than said first surface of said support tape.

6. The continuous element slide fastener as claimed in claim 2, wherein the highest position of said first protrusion of said pair of continuous-type coupling elements is higher than said first surface of said support tape.

7. The continuous element slide fastener as claimed in claim 1, wherein said fastening surface of each of said continuous-type coupling elements is formed with a second protrusion.

8. The continuous element slide fastener as claimed in claim 1, wherein said continuous-type coupling element is selected from a continuous-coil type coupling element or a continuous-folding type coupling element.

9. The continuous element slide fastener as claimed in claim 2, wherein said continuous-type coupling element is selected from a continuous-coil type coupling element or a continuous-folding type coupling element.

10. The continuous element slide fastener as claimed in claim 8, wherein said continuous-type coupling element has no cord therein and one narrow tape is disposed on the fastening surface of each said continuous-type coupling element, said narrow tape being bound together with one said continuous-type coupling element and one said support tape by at least one sewing stitch.

11. The continuous element slide fastener as claimed in claim 9, wherein said continuous-type coupling element has no cord therein and one narrow tape is disposed on the fastening surface of each said continuous-type coupling element, said narrow tape being bound together with one said continuous-type coupling element and one said support tape by at least one sewing stitch.

12. The continuous element slide fastener as claimed in claim 1, wherein said support tape of said slide fastener is processed with a treatment of applying a water repellent agent or fabricated by water repellent fibers.

13. The continuous element slide fastener as claimed in claim 2, wherein said support tape of said slide fastener is processed with a treatment of applying a water repellent agent or fabricated by water repellent fibers.

14. The continuous element slide fastener as claimed in claim 1, wherein a warp/weft knitting fabric having elasticity in a warp or a weft direction is adopted in a portion of said pair of support tapes where said pair of continuous-type coupling elements not being disposed.

15. The continuous element slide fastener as claimed in claim 2, wherein a warp/weft knitting fabric having elasticity in a warp or a weft direction is adopted in a portion of said pair of support tapes where said pair of continuous-type coupling elements not being disposed.

16. The continuous element slide fastener as claimed in claim 1, wherein said pair of continuous-type coupling elements and said pair of support tapes have different colors.

17. The continuous element slide fastener as claimed in claim 2, wherein said pair of continuous-type coupling elements and said pair of support tapes have different colors.

18. The continuous element slide fastener as claimed in claim 2, wherein said inward abutting surface of said slider is formed with an inward abutting ridge, and a height of said inward abutting ridge is lower than 0.25 mm.

19. The continuous element slide fastener as claimed in claim 2, wherein said inward abutting surface of said slider is not formed with an inward abutting ridge.

20. The continuous element slide fastener as claimed in claim 2, wherein said inward abutting surface or said inward abutting bottom surface of said slider is formed with a first concave slot at a location corresponding to said first protrusion for receiving said first protrusion.

21. The continuous element slide fastener as claimed in claim 20, wherein said fastening surface of said continuous-type coupling element is formed with a second protrusion, and said inward abutting bottom surface of said slider is formed with a second concave slot at a location corresponding to said second protrusion for receiving said second protrusion.
